(19) United States
(12) Patent Application Publication
(10) Pub. No.: US 2005/0102632 A1
(43) Pub. Date: May 12, 2005

(54) Creating user interfaces

(76) Inventors: Uwe Klinger, Bad Schoenborn (DE); Martin Scholz, Nussloch (DE)

Correspondence Address: FISH & RICHARDSON, P.C., 3300 DAIN RAUSCHER PLAZA, 60 SOUTH SIXTH STREET, MINNEAPOLIS, MN, 55402, US

(21) Appl. No.: 10/704,988

(22) Filed: Nov. 10, 2003

(51) Int. Cl. G06F 3/00; G06F 17/24

(52) U.S. Cl. 715/789; 715/900; 715/788; 715/517

(57) ABSTRACT

Creating a computer user interface may comprise creating a first user interface by applying a layout algorithm to a plurality of user interface controls having a specified order. The first user interface may be displayed such that a user can enter a modification of the first user interface. The plurality of user interface controls may be updated with the modification received from the user. A second user interface may be created by applying the layout algorithm to the updated plurality of user interface controls. The user may select a new layout algorithm to be applied to the updated user interface controls.

### TECHNICAL FIELD

This description relates to creating computer user interfaces.

### BACKGROUND

User interfaces typically include a collection of fields, input fields and other user interface controls, boxes, frames, and other elements. User interface controls allow a user to interact with applications underlying the user interface and facilitate meaningful input and output of data. User interfaces are often created from “scratch,” that is, they are generated by assembling the controls into a desired layout to form the user interface. Layout algorithms have been used for assembling user interface controls, and they may include logic for how to place the controls.

A component known as a screen painter has been used for generating user interfaces. It may be capable of receiving the controls that are to be placed on the resulting user interface. The screen painter developed and provided by SAP AG, for example, can be used to create panels for the original screen representation in the R/3 system. The screen painter does not offer the use of layout algorithms. A disadvantage is that the controls must be specified as to their location; that is, their location coordinates must be defined, either in pixel coordinates or relative to a layout grid. Typically, it is difficult to create a “user friendly” interface with this tool. In addition, the resulting screens are often optimized for a specific screen size or type of output device, and they do not work as well when they are applied on a different device.

### SUMMARY

The invention relates to creating computer user interfaces. In a first general aspect, a method of creating a computer user interface comprises creating a first user interface by applying a layout algorithm to a plurality of user interface controls having a specified order. The first user interface is displayed such that a user can enter a modification of the first user interface. The plurality of user interface controls is updated with the modification received from the user. A second user interface is created by applying the layout algorithm to the updated plurality of user interface controls.

In selected embodiments, the user enters the modification using a drag and drop function.

A layout algorithm may be applied following introduction of a new user interface control, relocation of at least one of the user interface controls, inclusion of a group for user interface controls, or modification of an attribute associated with one of the user interface controls.

In a second general aspect, a computer system for creating user interfaces comprises user interface controls having a specified order, a layout algorithm that can be applied to the user interface controls, and a user interface creation module creating a first user interface by applying the layout algorithm to the user interface controls. The user interface creation module displays the first user interface such that a user can enter a modification of the first user interface. The user interface creation module updates the user interface controls with the modification received from the user and creates a second user interface by applying the layout algorithm to the updated user interface controls.

In selected embodiments, the computer system comprises a plurality of layout algorithms and a layout algorithm selector for a user to select at least one of the plurality of layout algorithms. The user interface creation module applies the selected layout algorithm in creating a third user interface.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIGS. 1A-C are exemplary screen snapshots of creating a user interface;

FIG. 2 is a block diagram of a computer system that can generate the screen snapshots shown in FIGS. 1A-C;

FIG. 3 is a flow chart of a method of creating a user interface; and

FIG. 4 is a list with examples of user interface controls that can be used in creating a user interface.

Like reference numbers in the various drawings indicate like elements.

### DETAILED DESCRIPTION

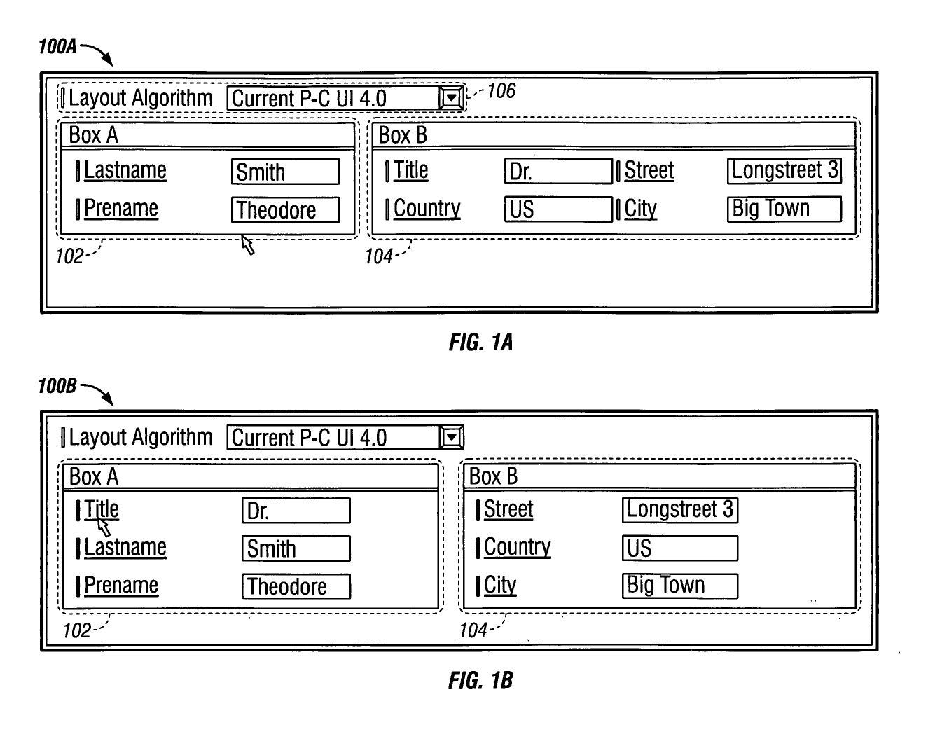

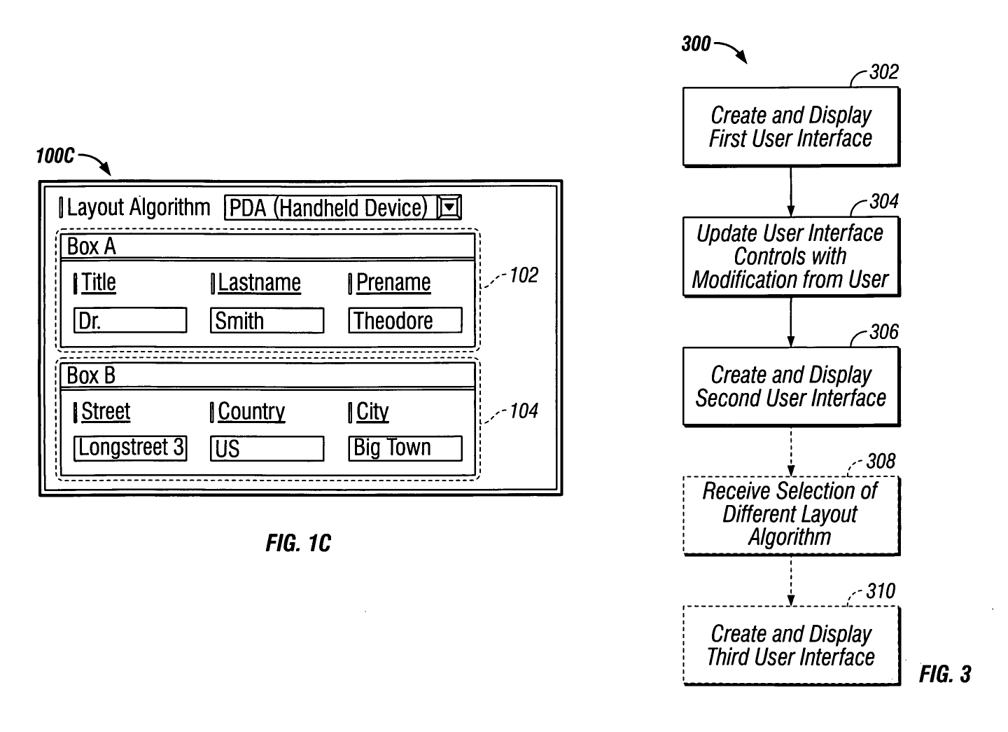

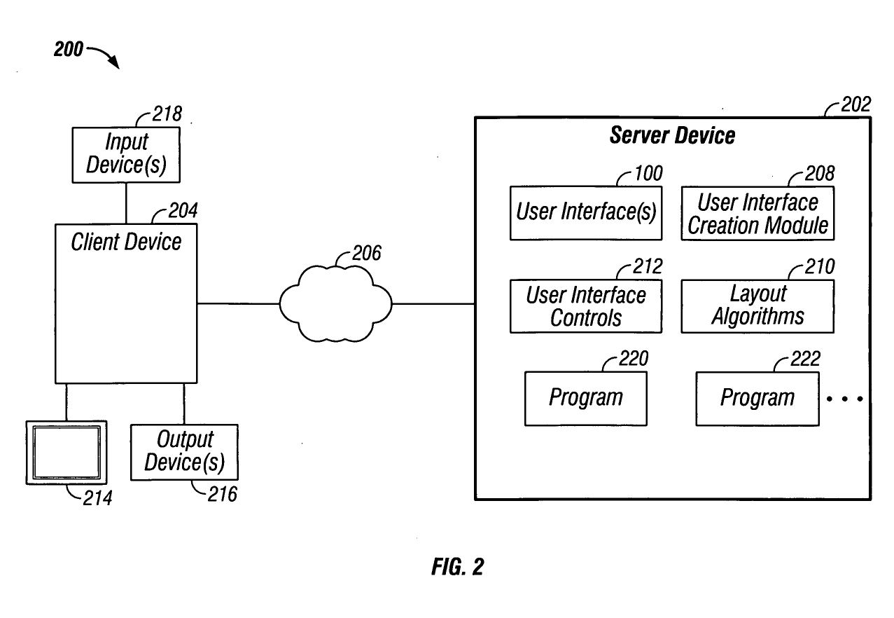

An embodiment of the invention will be described with reference to FIG. 1A. A user interface 100A is created 302 (see FIG. 3) and displayed to a user. The user interface 100A comprises a group 102 of two input fields labeled “Lastname” and “Prename” respectively, and a group 104 with input fields labeled “Title,” “Street,” “Country” and “City,” respectively. The user interface 100A was created 302 by applying a layout algorithm 210 (see FIG. 2) to user interface controls 212 (see FIG. 2). The layout algorithm 210 arranges the user interface controls 212 according to its logic. The currently used layout algorithm 210 is listed in a layout algorithm selector (LAS) 106. Preferably, the LAS 106 is visible to facilitate receiving 308 (see FIG. 3) of a selection by the user of a different layout algorithm 210 to be applied, and is not visible when the user interface 100A is put to its intended use.

The user interface 100A is displayed using a “what-you-see-is-what-you-get” (WYSIWYG) functionality and can conveniently be modified by the user. In this example, the user moves the “Title” input field from group 104 to group 102 using a drag and drop (“D&D”) function. That is, the user may select the field that should be moved, for example using input device(s) 218 (see FIG. 2) such as a pointer device, and place the selected field in a different location in the user interface 100A. The user interface controls 212 are updated 304 (see FIG. 3) with the user's modification. The layout algorithm 210 is applied to the updated user interface controls 212 to create 306 (see FIG. 3) a resulting user interface 100B which is shown in FIG. 1B. The “Title” field now precedes the “Lastname” field in box 102. The layout algorithm 210 vertically arranges the fields of the group 102 and the remaining fields of the group 104. In this example, the layout algorithm 210 did not alter the relative positions of groups 102 and 104 when the user interface 100B was created.

The D&D function may be implemented by marking the fields of the user interfaces 100A, B as D&D sources and D&D targets. When the user drags a field, the D&D function recognizes it as a D&D source and prepares to receive information for a target location from the user—that is, the position where the user places the field. When the user drops the field, the target location is used in updating 304 the user interface controls 212.

The D&D function may be used to introduce groups, fields or other user interface controls into the user interfaces 100A, B. For example, the user drags a new field onto the user interface(s) 100A, B and drops it there, or drags an existing field out of the user interface(s) 100A, B to remove it. As another example, a user drags an empty group onto the user interface(s) 100A, B and places one or more fields inside it using D&D. In some implementations, the layout algorithm 210 is applied following every modification entered by the user, such as the introduction or relocation of a user interface control or of a group. In selected implementations, the layout algorithm may be applied following a predetermined time during which no user input has been received. Another example is that applying the layout algorithm can be triggered by a request from the user.

The LAS 106 can be used to apply a different layout algorithm to the user interface controls 212. In this example, the LAS 106 is a drop down list menu where the user can select between listed layout algorithms 210. The exemplary layout algorithm used in creating 302, 306 the user interfaces 100A and B is labeled “Current P-C UI 4.0”. If a selection of a different layout algorithm is received 308, here a layout algorithm labeled “PDA (Handheld Device),” a new user interface may be created 310 (see FIG. 3). The new user interface 100C may look as shown in FIG. 1C. The newly selected layout algorithm 210 causes the groups 102 and 104 to be placed vertically above each other, and the fields of each group are arranged in a horizontal row. The user can enter further modifications to the user interface 100C, for example using D&D or by selecting another layout algorithm 210.

FIG. 2 shows a computer system 200 capable of creating user interfaces. A server device 202 is connected to a client device 204 through a network 206. The server device 202 comprises a user interface creation module (UICM) 208 that creates 302 a user interface 100 (collectively referring to the user interfaces 100A, B, C and others) by applying a layout algorithm 210 to user interface controls 212 having a specific order. The user interface 100 can be displayed on a display device 214. For example, the user may utilize the display device 214, output device(s) 216 or input device(s) 218—operably connected to the client device 204—to interact with one or more programs 220, 222, and so on, on the server device. If the user modifies the user interface 100, the UICM 208 updates 304 the user interface controls 212. The UICM 208 creates 306 a new user interface 100 by applying the layout algorithm 210 to the updated user interface controls 212.

This exemplary system 200 involves a client-server architecture. Other embodiments of the inventive system need not have a client-server architecture, and may for example include a single computer device.

An example of updating 304 the user interface controls 212 will now be described. The user interface controls 212 may be associated with data objects that are relevant to the particular program(s) for which the user interface is being created. Referring briefly to FIG. 1A, the associations shown in Table 1 may exist in the server device 202 for the fields in group 102:

TABLE 1

| Data Object | User Interface Control |
|---|---|
| Last Name | Input Field |
| Prename | Input Field |

Thus, the data objects “Last Name” and “Prename” in Table 1 are both associated with user interface controls 212 that are input fields, and that have the order specified in Table 1.

The user interface controls 212 will be updated 304 following a modification of the user interface by the user. In some implementations, this may comprise a “reverse mapping” of information entered by the user to the storage of the user interface controls 212. Assume that the user modifies the user interface 100A by selecting the “Title” field and placing it on the “Lastname” field. The updating of the user interface controls 212 corresponding to this modification may involve changing Table 1 to the following Table 2:

TABLE 2

| Data Object | User Interface Control |
|---|---|
| Title | Input Field |
| Last Name | Input Field |
| Prename | Input Field |

Following the user's modification, the UICM 208 determines that the user interface controls 212 should be updated to include the “Title” input field—and the “Title” data object associated with it—before the “Last Name” data object, as shown in Table 2. Thus, updating 304 may comprise moving a user interface control from a previous position in the specified order to a new position. Other changes in the user interface 100 may result in similar updates of the user interface controls 212. For example, updating 304 may comprise adding at least one new user interface control at a selected position in the specified order.

FIG. 3 shows a flow chart of a method 300 of creating a user interface. Preferably, the method 300 is performed by the server device 202. For example, a computer program product may comprise instructions that cause a processor of the server device 202 to perform the steps of method 300. Method 300 comprises the following steps:

Create 302 the first user interface 100A by applying a layout algorithm 210 to user interface controls 212. The user interface 100A is displayed such that the user can enter a modification of it.

Update 304 the user interface controls 212 with the modification received from the user.

Create 306 the second user interface 100B by applying the layout algorithm 210 to the updated user interface controls 212.

Optionally, the UICM 208 receives 308 a selection by the user of a different layout algorithm 210, and creates 310 a third user interface 100C by applying the different layout algorithm to the updated user interface controls 212. The UICM 208 may display the third user interface 100C and the user may enter a modification of it or select a different layout algorithm to be applied.

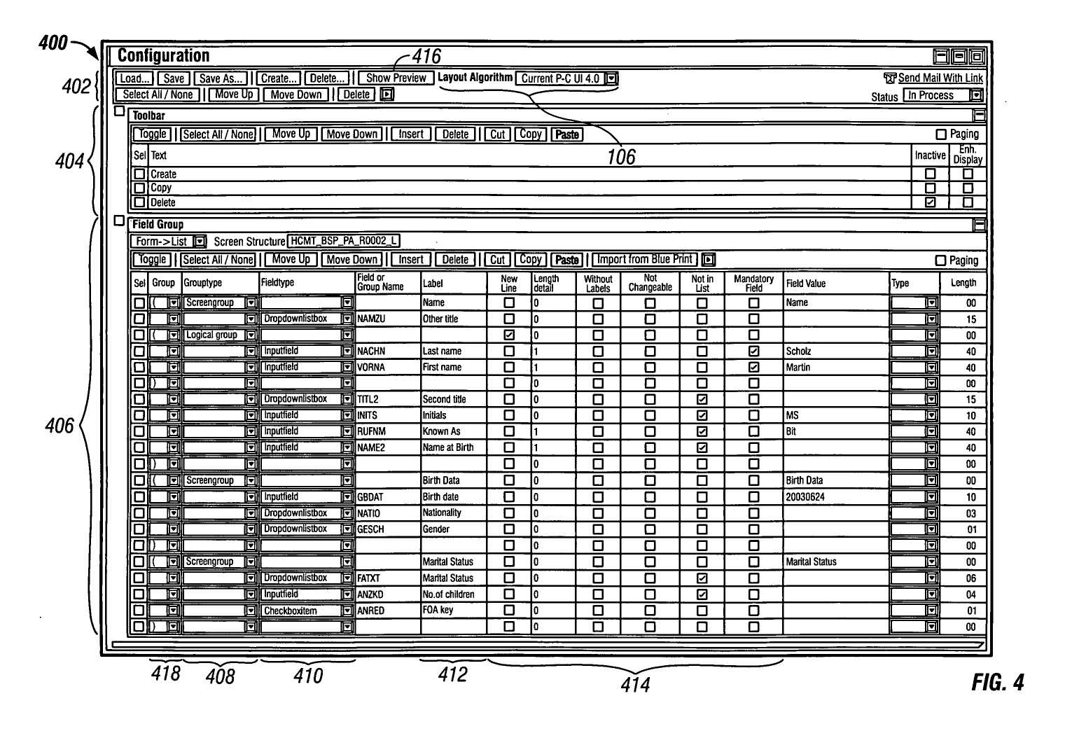

The user can modify or specify the order of user interface controls 212 before or after the user interface is created. This may be done using panel 400 shown in FIG. 4, which may be presented on display device 214. The toolbar(s) and field(s) listed in areas 404 and 406 will be included in the user interface. Accordingly, panel 400 may be where the user initially defines the user interface controls 212 that are to be included in the user interface. Panel 400 may also be used to modify attributes of controls in an existing user interface.

A control management area 402 lets the user load and save user interface controls 212 for one or more toolbar groups 404 and field groups 406. A toolbar group 404 contains a configuration of a toolbar for the user interface, and a field group 406 contains a list of controls for the user interface. A group type column 408 lets the user select between types of groups that can contain fields for the user interface. For example, the groups 102 and 104 are examples of the “Screengroup” type; “Logical group” may signify that the fields contained in the group are kept on a single row of the resulting user interface. A field type column 410 lets the user select the type of field. Input fields have been described above in connection with the groups 102 and 104; other examples of field types include drop down list box and check box item. Labels for the fields are listed in label column 412. The columns referred to collectively as 414 comprise other optional attributes for the fields, including:

New Line: Whether the UICM 208 should begin a new line in the user interface for displaying the specific field.

Length detail: the field width (as a number of columns) in a column based user interface; if zero is entered, the UICM 208 determines the width required by the field.

Without Labels: Whether the label in column 412 is displayed with the field.

Not Changeable: Whether the field can be modified in the user interface.

Not in List: A user interface can provide a screen that can be toggled between a form view (where a number of fields pertaining to one database object are displayed) and a list view (where selected fields of several database objects are displayed in list form). The Not in List column indicates that the specific field is displayed only in the form view, not in the list view.

Mandatory Field: Whether the user must enter a value in the field.

The panel 400 includes the LAS 106 by which the user can select a layout algorithm to be applied to the listed user interface controls 212. In some implementations, the layout algorithm is applied following every modification made to any of the user interface controls, such as any change of settings in field group 406. The user may activate a “Show Preview” button 416 to cause the UICM 208 to create a user interface based on the current settings. For example, the “Show Preview” button 416 causes the layout algorithm selected in LAS 106 to be applied.

The specified order of the user interface controls 212 may include that certain controls are grouped together, like the exemplary groups 102 and 104 above. A grouping column 418 lets the user indicate which controls are grouped together. For example, the beginning and end of a group may be indicated by a left and right parenthesis, respectively, in column 418. Accordingly, when the grouping of controls changes, such as in moving the “Title” field from group 104 to group 102 described above, the specified order is updated correspondingly.

Creating user interfaces as described herein may offer any of the following advantages. Improved user interface creation. Convenient user modification of a created user interface. Permitting user interface controls to be specified only as to their type and their respective order, without location coordinates or grid coordinates. Flexible selection between different layout algorithms and convenient application of the selected layout algorithm to create a user interface. Improved consistency when creating multiple user interfaces.

The invention can be implemented in digital electronic circuitry, or in computer hardware, firmware, software, or in combinations of them. Apparatus of the invention can be implemented in a computer program product tangibly embodied in an information carrier, e.g., in a machine-readable storage device or in a propagated signal, for execution by a programmable processor; and method steps of the invention can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the invention can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The invention can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

A number of embodiments of the invention have been described. Nevertheless, it will be understood that various modifications may be made without departing from the spirit and scope of the invention. Accordingly, other embodiments are within the scope of the following claims.

1. A method of creating a computer user interface, the method comprising:
creating a first user interface by applying a layout algorithm to a plurality of user interface controls having a specified order, the first user interface being displayed such that a user can enter a modification of the first user interface;
updating the plurality of user interface controls with the modification received from the user; and
creating a second user interface by applying the layout algorithm to the updated plurality of user interface controls.

2. The method of claim 1, wherein the modification comprises a relocation of at least one of the user interface controls and wherein updating the plurality of user interface controls comprises moving the at least one user interface control from a previous position in the specified order to a new position.

3. The method of claim 1, wherein the modification comprises adding at least one new user interface control and wherein updating the plurality of user interface controls comprises introducing the new user interface control at a selected position in the specified order of the plurality of user interface controls.

4. The method of claim 1, wherein the modification is entered using a drag and drop function.

5. The method of claim 1, wherein creating the second user interface comprises applying the layout algorithm following a predetermined time without user input.

6. The method of claim 1, wherein creating the second user interface comprises applying the layout algorithm following receipt of a request from the user to apply the layout algorithm.

7. The method of claim 1, wherein creating the second user interface comprises applying the layout algorithm following each occurrence of one selected from the following group: introduction of a new user interface control, relocation of at least one of the user interface controls, inclusion of a group for user interface controls, modification of an attribute associated with one of the user interface controls, and combinations thereof.

8. The method of claim 1, further comprising receiving a selection by the user of a different layout algorithm and creating a third user interface by applying the different layout algorithm to the updated user interface controls.

9. A computer system for creating user interfaces, the computer system comprising:
user interface controls having a specified order;
a layout algorithm that can be applied to the user interface controls; and
a user interface creation module creating a first user interface by applying the layout algorithm to the user interface controls, the user interface creation module displaying the first user interface such that a user can enter a modification of the first user interface;
wherein the user interface creation module updates the user interface controls with the modification received from the user and creates a second user interface by applying the layout algorithm to the updated user interface controls.

10. The computer system of claim 9, wherein the user interface creation module updates the user interface controls by moving at least one user interface control from a previous position in the specified order to a new position.

11. The computer system of claim 9, wherein the user interface creation module updates the user interface controls by introducing a new user interface control at a selected location in the specified order of the plurality of user interface controls.

12. The computer system of claim 9, wherein the user interface creation module applies the layout algorithm following each occurrence of one selected from the following group: introduction of a new user interface control, relocation of at least one of the user interface controls, inclusion of a group for user interface controls, modification of an attribute associated with one of the user interface controls, and combinations thereof.

13. The computer system of claim 9, further comprising a plurality of layout algorithms and a layout algorithm selector for a user to select at least one of the plurality of layout algorithms, wherein the user interface creation module applies the selected layout algorithm in creating a third user interface.

14. The computer system of claim 9, wherein the user interface creation module provides a WYSIWYG functionality for displaying the first and second user interfaces and for receiving the modification from the user.

15. The computer system of claim 9, wherein the user interface creation module provides a drag and drop function for the user to enter the modification.

16. A computer program product containing executable instructions that when executed cause a processor to perform operations comprising:
create a first user interface by applying a layout algorithm to a plurality of user interface controls having a specified order, the first user interface being displayed such that a user can enter a modification of the first user interface;
update the plurality of user interface controls with the modification received from the user; and
create a second user interface by applying the layout algorithm to the updated plurality of user interface controls.
